(19) United States
(12) Patent Application Publication
(10) Pub. No.: US 2026/0106096 A1
(43) Pub. Date: Apr. 16, 2026

(54) ON-OFF ASSEMBLY OF INTELLIGENT DIMMER, AND DIMMER

(71) Applicant: Wenzhou Huaya Electric Co., Ltd., Wenzhou (CN)

(72) Inventors: Pan LIN, Wenzhou (CN); Jinfeng CHEN, Wenzhou (CN)

(21) Appl. No.: 19/011,423

(22) Filed: Jan. 6, 2025

(30) Foreign Application Priority Data
Oct. 12, 2024 (CN) 2024114205481

(51) Int. Cl. H01H 23/14; F21V 23/04; F21Y 115/10; H01H 23/02

(52) U.S. Cl. CPC H01H 23/14; F21V 23/04; F21Y 2115/10; H01H 23/025; H01H 2231/052

(57) ABSTRACT

Disclosed are an intelligent dimmer and a structure of an on-off assembly thereof. A first key device in the on-off assembly includes a rocker key and a movable ejector rod, one end of which is connected to an ejector rod spring and the other end of which is arranged in a groove. The movable ejector rod cooperates with a moving contact assembly including two moving contacts and two contact surfaces, the contact surfaces are connected to the corresponding moving contacts, and the moving contact assembly is connected to a circuit in a printed circuit board (PCB). The movable ejector rod is arranged between the two contact surfaces, and the rocker key is capable of driving the movable ejector rod to swing and act on the corresponding contact surface, such that the moving contact assembly swings and is connected to or disconnected from a corresponding stationary contact.

### CROSS-REFERENCE TO RELATED APPLICATIONS

The present application claims priority to Chinese Patent Application No. 2024114205481, filed on Oct. 12, 2024, the entire disclosure of which is incorporated herein by reference.

### TECHNICAL FIELD

The present disclosure relates to an on-off assembly of an intelligent dimmer, and further relates to an intelligent dimmer including the on-off assembly.

### BACKGROUND

A light-emitting diode (LED) is a new type of green light source, and some LED lamps also have a variety of illumination modes. Control and setting of a switch on a wall usually need multiple times of pressing of the switch to achieve the adjustment to an appropriate mode. The prior art also includes a pressure-regulating switch, such as the Chinese patent titled with Intelligent Dimmable LED Lamp and with the publication No. CN220851813U. According to the patent, regulation is achieved through a rotary knob. Specifically, the rotary knob is rotated to cooperate with components such as a rotating rod, a touch rod A, a touch rod B, a touch pad A and a touch pad B, so as to drive the touch rod A and the touch rod B to touch the touch pad A and the touch pad B left and right, thereby achieving the function of regulating light. However, when the pressure-regulating switch is applied to a wall switch, it is not beautiful, and the rotary know can only be used for adjusting the light. An additional control switch is required to turn LED lamp on and off.

### SUMMARY

Aiming at the above defects, an objective of the present disclosure is to provide an on-off assembly of an intelligent dimmer, and another objective of the present disclosure is to provide a dimming and controlling integrated pressing type dimmer switch.

Therefore, an on-off assembly of an intelligent dimmer of the present disclosure includes a first key device, where the first key device includes a rocker key, and the on-off assembly further includes a movable ejector rod. One end of the movable ejector rod is connected to an ejector rod spring, the other end of the ejector rod spring is arranged in a groove at a lower side of the rocker key, and the movable ejector rod cooperates with a moving contact assembly. The moving contact assembly includes two moving contacts and two contact surfaces, the contact surfaces are connected to the corresponding moving contacts, and a middle of the moving contact assembly is connected to a circuit in a printed circuit board (PCB). The other end of the movable ejector rod is arranged between the two contact surfaces, and the rocker key is capable of driving the movable ejector rod to swing and act on the corresponding contact surface, such that the moving contact assembly swings and is connected to or disconnected from to a corresponding stationary contact.

Preferably, the moving contact assembly includes a copper plate with a downward bent and concave middle, and the moving contacts are arranged on wing plates on both sides of the copper plate. A limiting groove is arranged at the concave portion of the middle of the copper plate in a transverse direction, the limiting groove cooperates with a limiting strip, and the limiting strip is made of a conductive material and connected to the PCB, such that the moving contact assembly swings around a limiting portion when the moving contact assembly is subjected to the swing action of the ejector rod.

Preferably, the intelligent dimmer further includes a dimming assembly for dimming a lamp source, where the dimming assembly includes a second key device for adjusting brightness of the lamp source, and the rocker key and second keys are arranged on a housing of the dimmer.

Preferably, the second key device includes an up-regulation key and a down-regulation key, and the second key device includes pressing members. The dimming assembly includes column bodies connected to the pressing members, key springs arranged on the column bodies in a sleeving manner, and contacts cooperating with the column bodies, and the contacts are connected to a dimming circuit on the PCB.

Preferably, the pressing members are in a shape of C with a downward opening, and outer side plates of the pressing members are provided with limiting blocks cooperating with second key mounting grooves.

Preferably, the housing includes a base and a middle base, the base is suitable for placing the PCB, the PCB is connected to a columnar inner base, and the moving contact assembly and the stationary contact are arranged in the inner base. The inner base passes through a hole at a middle base fixing plate, the middle base is arranged above the middle base fixing plate and connected to the base, and a grounding bracket is arranged between the middle base and the middle base fixing plate. The rocker key is connected to the middle base, and the inner base is provided with clamping pins and used for being connected to a bottom of a rocker key mounting groove of the middle base.

Preferably, the middle base includes the rocker key mounting groove and the second key mounting grooves, and holes through which the movable ejector rod and the column body pass are provided in the rocker key mounting groove, the second key mounting grooves, the grounding bracket and the middle base fixing plate. A rotating shaft is transversely arranged in the middle of the rocker key, and a hole cooperating with the rotating shaft is correspondingly provided at the rocker key mounting groove, such that the rocker key swings along the rotating shaft.

Preferably, the middle base is provided edges, lower surfaces of the edges are fixed to clamping pins, and the clamping pins are in a sheet shape and provided with clamping grooves in middles for clamping. Holes in communication with the clamping grooves are provided at the edges of the middle base, and clamping blocks corresponding to the clamping pins of the middle base are arranged on side plates of the base, such that the middle base is connected to the base in a clamped manner.

Preferably, the middle base fixing plate is provided with wiring grooves, the base is provided with U-shaped openings, and the wiring grooves correspond to the U-shaped openings. The wiring grooves are suitable for mounting wiring assemblies, and each wiring assembly includes a U-shaped assembly and a rectangular clamping plate cooperating with the U-shaped assembly.

Preferably, a bottom plate of the base is provided with wiring holes through which a lead wire passes or is not provided with the wiring holes, and the lead wire is connected to the wiring assemblies from the wiring holes or an outside of the base.

The present disclosure has the beneficial technical effects:
(1) According to the present disclosure, the on-off assembly of the intelligent dimmer is provided with the rocker key, the movable ejector rod and the moving contact assembly, and the moving contact assembly is provided with two contact surfaces cooperating with the movable ejector rod. The swing of the rocker key is utilized to drive the movable ejector rod to act on one of the contact surfaces, such that the moving contact swings to achieve connection and disconnection between the moving contact and the stationary contact.
(2) The intelligent dimmer of the present disclosure integrates a pressing type dimmer switch and an on-off switch, where the pressing type dimmer switch structurally includes contacts, keys and springs. When the keys are pressed, the contacts will be short-circuited, thus allowing a current in the circuit to pass through and realize switch control. This design allows the brightness of light to change continuously and smoothly, thereby providing a convenient and intuitive way to adjust the indoor light, and the on-off switch realizes the on-off control over the circuit.
(3) In a particular example of the present disclosure, the housing of the dimmer switch is connected in a clamping and buckling manner, which is more convenient to disassemble and assemble compared with a traditional fixing manner through bolts.

### BRIEF DESCRIPTION OF THE DRAWINGS

FIG. 1 is a schematic diagram of a particular example for implementing the present disclosure.

FIG. 2 is an exploded diagram.

FIG. 3 is a top view.

FIG. 4 is a schematic diagram of a base.

FIG. 5 is a schematic diagram of a bottom of a rocker key.

FIG. 6 is a schematic diagram of an inner base.

FIG. 7 is a schematic diagram of a middle base fixing plate.

FIG. 8 is a schematic diagram of a moving contact assembly.

FIG. 9 is a schematic diagram of a circuit of a printed circuit board (PCB).

FIG. 10 is a schematic structural diagram of a circuit of a PCB.

Reference numerals in figures: 1. base; 101. side plate; 102. U-shaped opening; 2. printed circuit board (PCB); 201. indicator lamp; 3. inner base; 4. middle base fixing plate; 401. wiring groove; 5. grounding bracket; 6. middle base; 601. rocker key mounting groove; 602. second key mounting groove; 603. clamping pin; 604. edge; 7. rocker key; 701. connecting pipe; 702. ejector rod spring; 703. movable ejector rod; 704. moving contact assembly; 7041. contact surface; 7042. moving contact; 7043. limiting groove; 8. wiring assembly; 801. U-shaped assembly; 802. rectangular clamping plate; 9. second key device; 901. key spring; and 10. wiring hole.

### DETAILED DESCRIPTIONS OF THE EMBODIMENTS

The present disclosure is described in detail below in combination with the drawings and the preferred examples.

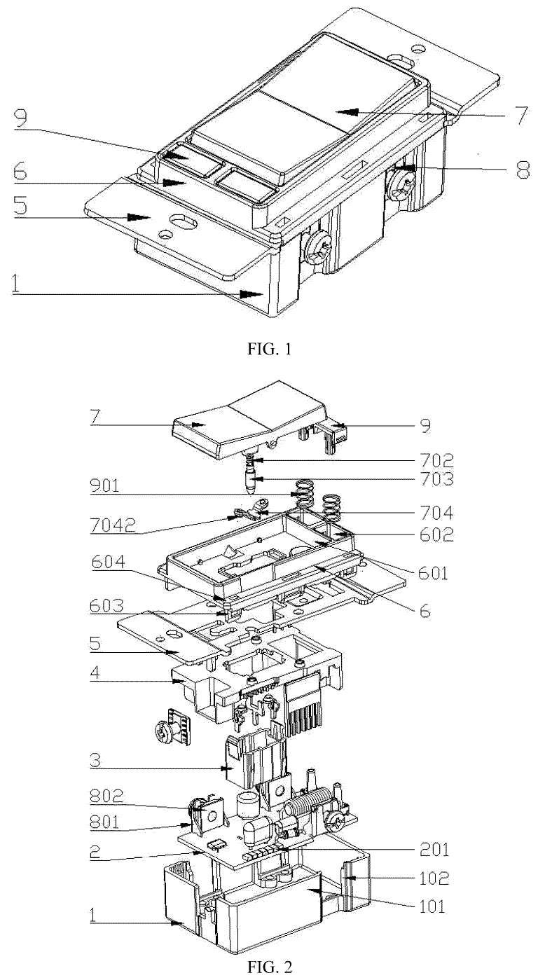

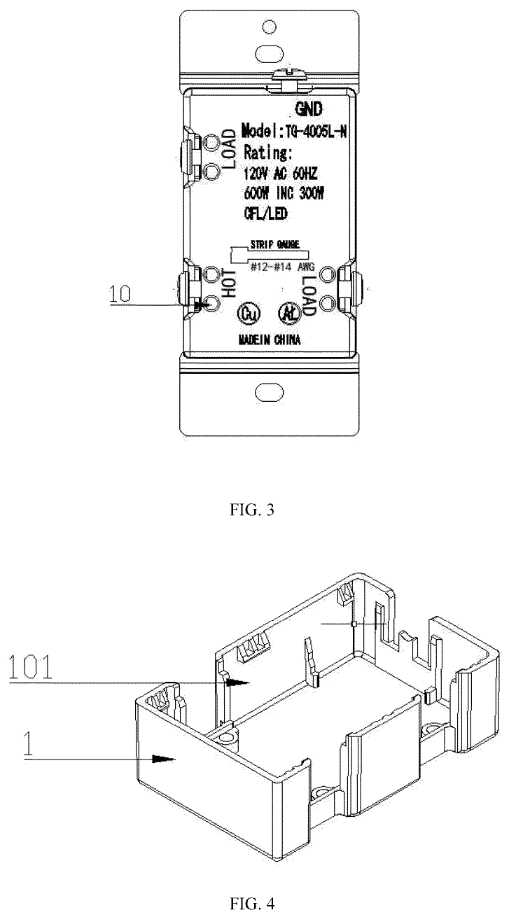

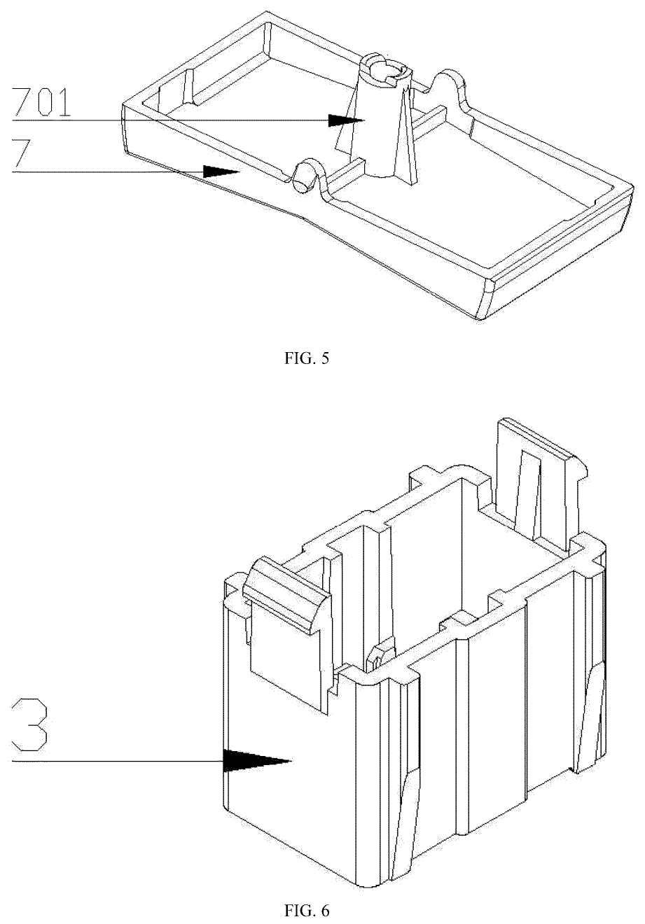

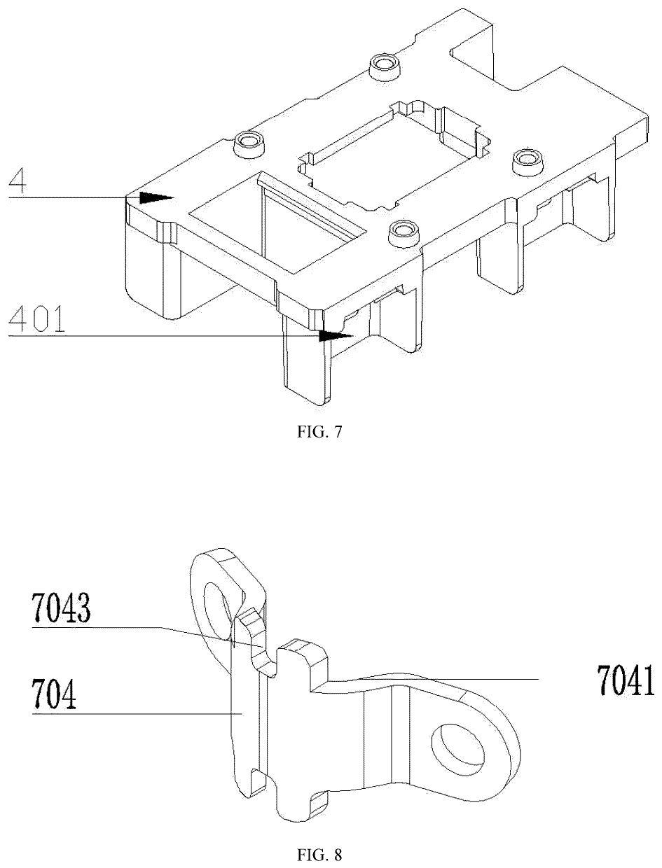

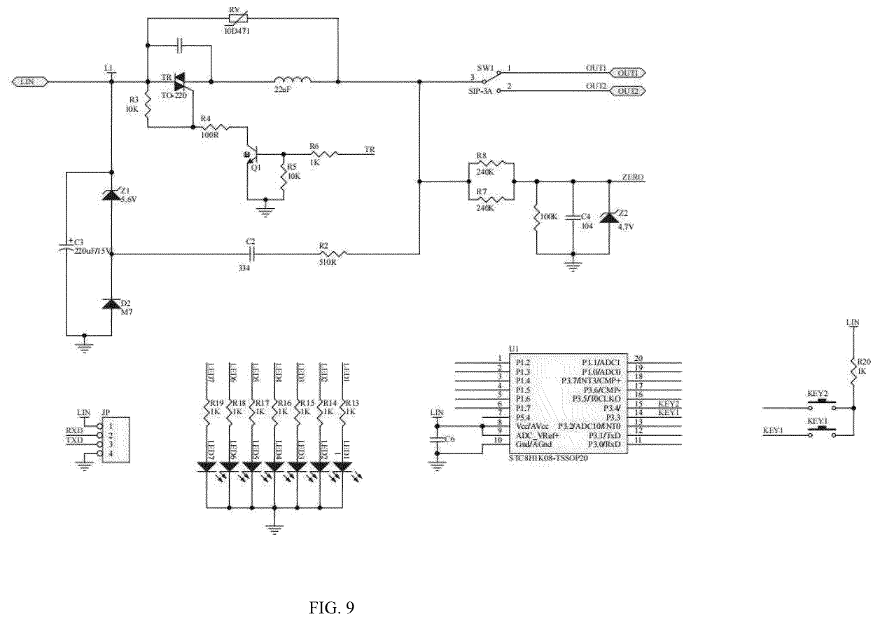

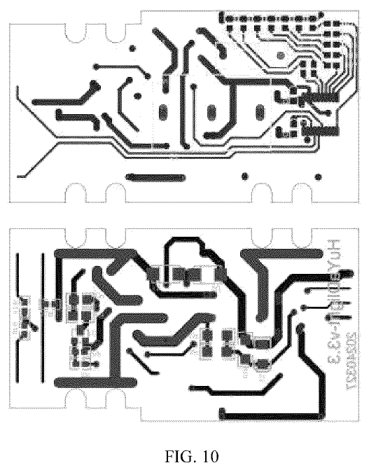

Referring to FIGS. 1-8, an intelligent dimmer of the present disclosure includes a housing, where an on-off assembly for a lamp source circuit and a dimming assembly for dimming a lamp source are mounted in the housing. The on-off assembly includes a first key device arranged on the housing, the dimming assembly includes a second key device 9 arranged on the housing, and the brightness of the lamp source is adjusted by pressing the second key device. In this example, the structure of the intelligent dimmer further includes a printed circuit board (PCB) 2, and a chip, a capacitor, an inductor and a light guide member are arranged on the PCB 2. The on-off assembly further includes a stationary contact and a moving contact assembly 704, and the first key device controls connection and disconnection between the moving contact assembly 704 and the stationary contact. The second key device 9 further includes column bodies and contacts below keys, and the contacts are connected to the PCB 2. In this example, the dimming assembly uses pressing type dimming, and is provided with an up-regulation key and a down-regulation key, and the working mode includes point-pressing and continuous pressing. The intelligent dimmer is preset with a plurality of gear positions for the intensity of illumination. When the working mode is point pressing (that is, the key is lifted after being pressed once), and the intensity of illumination is adjusted gear by gear. When the working mode is continuous pressing (the key is pressed and kept), the gear position is continuously adjusted. The up-regulation key and the down-regulation key have similar functions, the difference lies in that the up-regulation key is used for up regulation of the intensity of illumination, but the down-regulation key is used for down regulation of the intensity of illumination. Several light-emitting diode (LED) indicator lamps 201 are arranged on both sides of the PCB 2, and the indicator lamps 201 indicate that the down regulation or up regulation of the intensity of illumination or indicate the gear position after regulation through light changes. The PCB 2 and the circuit structure thereof are shown in FIG. 9 and FIG. 10. The intelligent dimmer of this example is not only applicable to LED lamps, but also applicable to other lamps, such as tungsten lamps and energy-saving lamps.

In the above example, as shown in FIG. 2, pressing members of the up-regulation key and the down-regulation key are in a shape of C with a downward opening. Outer side plates of the pressing members are provided with limiting blocks cooperating with second key mounting grooves 602, each second key mounting groove 602 includes a fixing plate at a bottom, holes are provided at both sides of each fixing plate, and groove walls of the second key mounting grooves 602 are provided with stop blocks cooperating with the limiting blocks. The column bodies are connected to key springs 901, and the limiting blocks prevent the up-regulation key or the down-regulation key from popping out. The holes at both sides of the fixing plates allows the outer side plates of the pressing members to pass through, such that the pressing members have enough strokes, and the key springs are used for resetting the up-regulation key or the down-regulation key.

In the above example, as shown in FIG. 2 and FIG. 8, the first key device includes a rocker key 7, an upper surface of the rocker key 7 forms a V-shaped symmetrical structure with an included angle of an obtuse angle, middles of two side surfaces of the rocker key each are connected to a rotating shaft, and the rotating shafts are inserted into the holes at the housing to realize swing of the rocker key. A middle of a lower surface of the rocker key 7 is fixed to a connecting pipe 701, the on-off assembly includes a movable ejector rod 703, one end, i.e. an upper end, of the movable ejector rod 703 is connected to an ejector rod spring 702, the other end of the push rod spring 702 is arranged in a groove of the connecting pipe 701 at a lower side of the rocker key 7, and the other end, i.e. a lower end, of the movable ejector rod 703 cooperates with the moving contact assembly 704. The moving contact assembly 704 and the stationary contact are mounted in an inner base 3. Specifically, the moving contact assembly 704 includes a copper plate with a downward bent and concave middle, two contact surfaces 7041 are formed on two sides of a concave area, and lower surfaces of wing plates at two sides of the copper plate are welded to or integrally provided with moving contacts 7042. A limiting groove 7043 is provided at the concave portion in the middle of the copper plate in a transverse direction, the limiting groove 7043 cooperates with a limiting strip, and the limiting strip is connected to the PCB 2 and connected to a circuit of the PCB. When the moving contact makes contact with any stationary contact, a conductive path can be formed to turn on the corresponding lamp source. The other end, i.e. the lower end, of the movable ejector rod 703 is arranged between the two contact surfaces 7041, and the movable ejector rod is pressed on the copper plate of the moving contact assembly under the action of the spring, and the acting force cooperates with the limiting groove and the limiting strip to limit the position of the copper plate. Meanwhile, the counter-acting force acts on the rocker key, such that when the rocker key swings to one side, the rocker key can be stably maintained in the state. When one side surface of the rocker key 7 is pressed, the rocker key 7 swings, and accordingly, the movable ejector rod 703 swings to the other side and acts on the corresponding contact surface 7041, such that the corresponding moving contact 7042 on the moving contact assembly 704 makes contact with the stationary contact for closing, and the circuit is conducted. In this example, the on-off of the two light sources can be controlled, and the dimming assembly can control the intensity of illumination of the light source corresponding to the on-off.

In the above example, referring to FIGS. 2-7, the housing includes a base 1, a middle base 6, the inner base 3, and a grounding bracket 5.

The base 1 includes a bottom plate and side plates 101, where the bottom plate is used for placing the PCB 2 and components thereof, and U-shaped openings 102 are provided at the side plates 101 for mounting wiring assemblies 8. The wiring mode includes internal wiring and external wiring. In the case of internal wiring, corresponding wiring holes 10 are provided at the bottom plate, and a lead wire is connected to the wiring assemblies 8 from the wiring holes 10. Each wiring assembly 8 includes a U-shaped assembly 801 and a rectangular clamping plate 802 cooperating with the U-shaped assembly, and a bolt passes through the U-shaped assembly 801 and the clamping plate to fix the lead wire. In the case of external wiring, no wiring holes need to be provided at the bottom plate, and the wiring assemblies 8 can be adjusted adaptively. The side plates 101 of the base 1 are provided with clamping blocks corresponding to clamping pins 603 of the middle base. Each clamping block includes an inclined plane. In this example, the clamping blocks are of right-angled triangular structures, and one or more grooves are provided at the inclined plane of each clamping block. The clamping blocks are used for cooperating with the clamping pins 603 on the middle base 6 to form clamping connection, the inclined plane structure is conductive to pressing and clamping, and the grooves at the inclined planes can be pressed by a tool to separate the clamping blocks 103 from the clamping pins 603 so as to realize disassembly.

An outer surface of the inner base 3 is columnar, and the inner base 3 is provided with the moving contact assembly 704 and the stationary contact. Referring to FIG. 5, the inner base 3 is fixed on the PCB 2 through welding, gluing, and other manners. A side wall of the inner base 3 passes through the hole provided at the middle base fixing plate 4 and matches a hole wall. The inner base 3 is provided with clamping pins extending upwards, and the clamping pins pass through the holes provided at the middle base fixing plate 4, the grounding bracket 5, and the rocker key mounting groove 601 and clamped at a bottom of the rocker key mounting 601.

The middle base 6 is arranged above the middle base fixing plate 4 and connected to the base 1, and includes the rocker key mounting groove 601 and the second key mounting grooves 602, where the rocker key is mounted in the rocker key mounting groove 601, and second keys are mounted in the second key mounting grooves 602. The middle base 6 is provided with edges 604, and the clamping pins 603 are fixed on lower surfaces of the edges 604. The clamping pins 603 are in a sheet shape, and clamping grooves are provided at lower ends of the clamping pins 603. The lower ends of the clamping pins 603 extend into the base 1, and the clamping blocks on the side wall of the base 1 are clamped into the clamping grooves to fix the middle base 6 and the base 1. The clamping grooves at the clamping pins 603 extend upwards, and holes are provided at the edges of the middle base 6 to be in communication with the clamping grooves. A tool can press the clamping blocks cooperating with the clamping grooves through the holes, such that the clamping blocks are separated from the clamping pins 603 for disassembly. The upper surface of the middle base 6 is provided with the rocker key mounting groove 601 and the second key mounting grooves 602, which are used for mounting the rocker key 7 in the on-off assembly and the up-regulation key and the down-regulation key in the dimming assembly respectively. A rotating shaft fixing portion is arranged at a bottom of the rocker key mounting groove 601 for fixing the rotating shaft of the rocker key 7. A fixing plate is arranged at the bottom of each second key mounting groove 602, holes are provided at both sides of each fixing plate, and stop blocks are arranged on both sides of the holes. The stop blocks are used for cooperating with limiting portions on the side walls of the pressing members of the second keys, such that the up-regulation key and the down-regulation key have sufficient downward movement strokes, and the up-regulation key and the down-regulation key limit the upward strokes of the pressing members when the key springs 901 rebound.

The surface, opposite the middle base 6, of the middle base fixing plate 4 is tightly connected to fixing columns through circular grooves. In this example, four circular pipes are fixed on an upper surface of the middle base fixing plate 4, and four corresponding fixing columns are arranged along the edges 604 of the middle base. The fixing columns pass through corresponding circular holes at the grounding bracket 5 and are tightly fixed to the circular grooves in the circular pipes in a matched manner. The middle base fixing plate 4 fixes a downward longitudinal plate, three sides of the longitudinal plate are enclosed to form wiring grooves 401 corresponding to the U-shaped openings 102 of the base 1, one sides of openings of the wiring grooves 401 face the U-shaped openings 102, and a bottom plate is arranged below the side plates. Each wiring assembly 8 includes a U-shaped assembly 801, a notch is provided at a longitudinal surface of each U-shaped assembly 801 facing the corresponding U-shaped opening 102, the notches are used for placing bolts, and the bolts are in threaded connection to the rectangular clamping plates 802. The rectangular clamping plates 802 cooperate with the U-shaped assemblies 801 for clamping and fixing the lead wire, and the position, where the lead wire is fixed, of the rectangular clamping plates can be preprocessed to form arc channels. Several transverse ribs can be arranged in the arc channel of each rectangular clamping plate 802 to press the lead wire, so as to ensure that the lead wire is in good contact with the U-shaped assemblies 801. The U-shaped assemblies 801 are made of copper, and pins are welded on the PCB 2. The rectangular clamp plates 802 can be aluminum plates. The rectangular structures are employed to cooperate with the side plates of the U-shaped assemblies to prevent the clamping plates from rotating when the bolts are screwed. The middle base fixing plate 4 may be provided with blocking strips extending towards the notches, a width of each blocking strip is less than or equal to a width of the notch, and the width of the notch is slightly greater than a diameter of the bolt. A lower side of each blocking strip is provided with an arc surface cooperating with the bolt, the two sides of each U-shaped opening 102 of the base 1 are provided with wall surfaces extending inwards, and upper ends of the wall surfaces form step surfaces. The middle base 6 is provided with corresponding blocking sheets, and lower surfaces of the blocking sheets make contact with the step surfaces. Inner side surfaces of the blocking sheets cooperate with the wiring grooves 401 to limit upper portions of the U-shaped assemblies 801, and the upper portions are restricted to outsides of the wiring assemblies 8.

The grounding bracket 5 is arranged between the middle base 6 and the middle base fixing plate 4, and circular and elliptical fixing holes are provided at two ends of the grounding bracket 5 for fixing the grounding bracket on a wall body through bolts or screws.

What is claimed is:

1. An on-off assembly of an intelligent dimmer, comprising a first key device, wherein the first key device comprises a rocker key, the on-off assembly further comprises a movable ejector rod, one end of the movable ejector rod is connected to an ejector rod spring, the other end of the ejector rod spring is arranged in a groove at a lower side of the rocker key, the movable ejector rod cooperates with a moving contact assembly, the moving contact assembly comprises two moving contacts and two contact surfaces, the contact surfaces are connected to the corresponding moving contacts, a middle of the moving contact assembly is connected to a circuit in a printed circuit board (PCB), the other end of the movable ejector rod is arranged between the two contact surfaces, and the rocker key is capable of driving the movable ejector rod to swing and act on the corresponding contact surface, such that the moving contact assembly swings and is connected to or disconnected from a corresponding stationary contact.

2. The on-off assembly of an intelligent dimmer according to claim 1, wherein the moving contact assembly comprises a copper plate with a downward bent and concave middle, the moving contacts are arranged on wing plates on both sides of the copper plate, a limiting groove is arranged at the concave portion of the middle of the copper plate in a transverse direction, the limiting groove cooperates with a limiting strip, and the limiting strip is made of a conductive material and connected to the PCB, such that the moving contact assembly swings around a limiting portion when the moving contact assembly is subjected to the swing action of the ejector rod.

3. An intelligent dimmer, comprising the on-off assembly according to claim 1, and further comprising a dimming assembly for dimming a lamp source, wherein the dimming assembly comprises a second key device for adjusting brightness of the lamp source, and the rocker key and second keys are arranged on a housing of the dimmer.

4. The intelligent dimmer according to claim 3, wherein the second key device comprises an up-regulation key and a down-regulation key, the second key device comprises pressing members, the dimming assembly comprise column bodies connected to the pressing members, key springs arranged on the column bodies in a sleeving manner, and contacts cooperating with the column bodies, and the contacts are connected to a dimming circuit on the PCB.

5. The intelligent dimmer according to claim 4, wherein the pressing members are in a shape of C with a downward opening, and outer side plates of the pressing members are provided with limiting blocks cooperating with second key mounting grooves.

6. The intelligent dimmer according to claim 3, wherein the housing comprises a base and a middle base, the base is suitable for placing the PCB, the PCB is connected to a columnar inner base, the moving contact assembly and the stationary contact are arranged in the inner base, the inner base passes through a hole at a middle base fixing plate, the middle base is arranged above the middle base fixing plate and connected to the base, a grounding bracket is arranged between the middle base and the middle base fixing plate, the rocker key is connected to the middle base, and the inner base is provided with clamping pins and used for being connected to a bottom of a rocker key mounting groove of the middle base.

7. The intelligent dimmer according to claim 6, wherein the middle base comprises the rocker key mounting groove and the second key mounting grooves, holes through which the movable ejector rod and the column body pass are provided in the rocker key mounting groove, the second key mounting grooves, the grounding bracket and the middle base fixing plate, a rotating shaft is transversely arranged in the middle of the rocker key, and a hole cooperating with the rotating shaft is correspondingly provided at the rocker key mounting groove, such that the rocker key swings along the rotating shaft.

8. The intelligent dimmer according to claim 7, wherein the middle base is provided edges, lower surfaces of the edges are fixed to clamping pins, and the clamping pins are in a sheet shape and provided with clamping grooves in middles for clamping; and holes in communication with the clamping grooves are provided at the edges of the middle base, clamping blocks corresponding to the clamping pins of the middle base are arranged on side plates of the base, such that the middle base is connected to the base in a clamped manner.

9. The intelligent dimmer according to claim 8, wherein the middle base fixing plate is provided with wiring grooves, the base is provided with U-shaped openings, the wiring grooves correspond to the U-shaped openings, the wiring grooves are suitable for mounting wiring assemblies, and each wiring assembly comprises a U-shaped assembly and a rectangular clamping plate cooperating with the U-shaped assembly.

10. The intelligent dimmer according to claim 9, wherein a bottom plate of the base is provided with wiring holes through which a lead wire passes or is not provided with the wiring holes, and the lead wire is connected to the wiring assemblies from the wiring holes or an outside of the base.
